(19) United States
(12) Patent Application Publication
(10) Pub. No.: US 2002/0146044 A1
(43) Pub. Date: Oct. 10, 2002

(54) Hybrid single/multiuser interference reduction detector

(76) Inventors: Riaz Esmailzadeh, Yokohama (JP); Jonas Karlsson, Yokohama (JP)

Correspondence Address: Jenkens & Gilchrist, P.C., 1445 Ross Avenue, Suite 3200, Dallas, TX, 75202, US

(21) Appl. No.: 09/829,463

(22) Filed: Apr. 9, 2001

(51) Int. Cl. H04J 3/02

(52) U.S. Cl. 370/542; 375/148

(57) ABSTRACT

A single user detection (SUD) unit is used to detect the dedicated physical control channel (DPCCH) of a received signal. This reduces interference from other users, provides higher quality for the control channel detection, and achieves short processing delays. Consequently, the detected control channel being used to enhance the detection of the data channel part of the received signal. The data detection process performed on the data channel being enhanced by using channel estimate information generated by the SUD unit. The data detection process is performed by a Multi-user detector, a single user detector or any conventional detector.

### BACKGROUND OF THE PRESENT INVENTION

1. Field of the Invention

The present invention relates generally to code division multi-access telecommunications systems and in particular to a method for an interference reduction technique using single/multi-user detectors (SUD/MUD).

2. Background of the Present Invention

In a Code Division Multiple Access (CDMA) system, a user signal is spread over a wide frequency bandwidth by an individual code and is transmitted in a common frequency band. The receiver detects a desired signal by a despreading process from the CDMA signal and the individual code. The spreading codes used for a CDMA system are chosen to have a relatively low cross-correlation between any two sequences in the set. However, interference nonetheless occurs in the CDMA system due to cross-correlation among the spreading codes assigned to users. Unlike other multiple access wireless communication methods, CDMA interference occurs mainly from users within the same cell, rather than users in other cells.

CDMA based systems have a soft capacity, meaning that there is no limit to the number of users on the network. However, an increase in the number of users may cause a degradation in the quality of service of the links, in view of the above mentioned cross-correlation factor. A major factor limiting user capacity in CDMA systems is user interference in the system. Thus, CDMA user capacity can be increased if multi-user interference is canceled.

Interference removal/reduction is performed by implementing either of two classes of techniques. One technique is multi-user detection (MUD), where signals of multiple users are detected, despread, and then used to cancel the interference caused on any particular user. The other technique is a single user detection (SUD) technique where the detection of the signal of one user is enhanced by suppressing the interference or influence of other signals in the system. In this technique the detector does not have to know the spreading sequence of the other users, only the spreading code for the user involved.

Although interference cancellation (IC) techniques have been known for over a decade, their implementation has been hampered by the complexity of their implementation and the excessive communication between several units of detectors which is necessary to carry out the operation. What is needed is a user detection interference reduction system and method wherein the detection of the received signals is accurate, and the interference is reduced in the detection process.

### SUMMARY OF THE INVENTION

The present invention is directed a system and method for accurately detecting signals. A single user detection (SUD) is applied to the dedicated physical control channel (DPCCH) part of a signal frame, which reduces interference signals from other users in the same cell and in other cells, provides higher quality for the DPCCH detection, and achieves short processing delays. Consequently, this results in better performance of the detection of the dedicated physical data channel (DPDCH) part of a signal frame, i.e., a better cancellation scheme using a multi-user detection (MUD) or a SUD. The DPDCH detection process is performed on the DPDCH part using the channel estimates of the SUD process, which is consequently used to enhance the detection of the DPDCH information.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 illustrates a conventional uplink transmission frame structure corresponding to CDMA-based communication;

FIG. 2 illustrates an exemplary base station in a cellular telecommunications system;

FIG. 3 illustrates a preferred embodiment of a receiver in a base station in the cellular telecommunications system;

FIG. 4 illustrates a preferred embodiment of a single user detector (SUD) used in a preferred embodiment of the present invention to despread user signals;

FIG. 5 illustrates a multi-user detector (MUD) in a preferred embodiment of the present invention used to detect the user signals; and

FIG. 6 illustrates the Interference Cancellation Unit (ICU) of the MUD described with reference to FIG. 5.

### DETAILED DESCRIPTION OF THE DRAWINGS

The numerous innovative teachings of the present application will be described with particular reference to the presently preferred exemplary embodiments However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

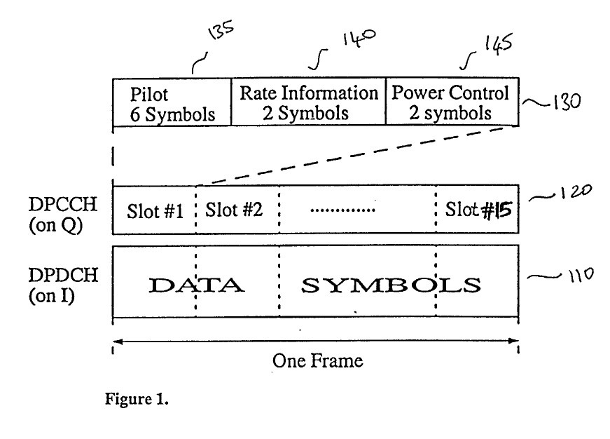

With reference to FIG. 1, there is illustrated therein a standard uplink transmission frame structure, sometimes called the reverse link, in the International Mobile Telecommunications 2000 (IMT2000) or other Code Division Multiple Access (CDMA) -based system. This uplink frame structure is designed on an Inphase/Quadrature (I/Q) basis where the control information, generally designated by the reference numeral 130, such as the pilot symbols 135 , rate information 140, referred to in the Wideband CDMA (WCDMA) standard as the Transport Format Combination Indicator (TFCI), and the power control 145 are transmitted on the Q-channel.

It should be understood that this portion of the uplink channel is called a dedicated physical control channel (DPCCH) 120. A data part 110 is transmitted over the I channel, which is called a dedicated physical data channel (DPDCH) 110. The control channel (DPCCH) frame 120 is divided into 15-slots. Each of the 15-slots 120 consists of ten symbols, of which two symbols convey information about the data channel (DPDCH) such as transmission rate and repetition or puncturing patterns. This information must be detected first before the interference cancellation processing of the DPDCH is carried out.

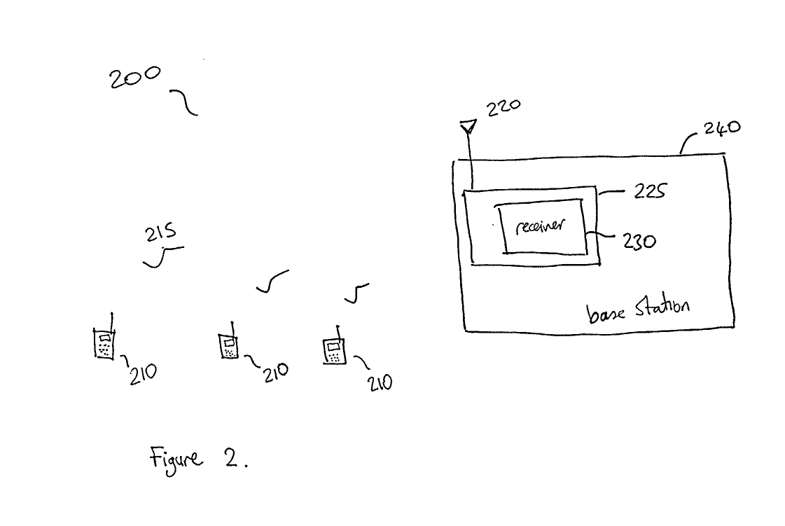

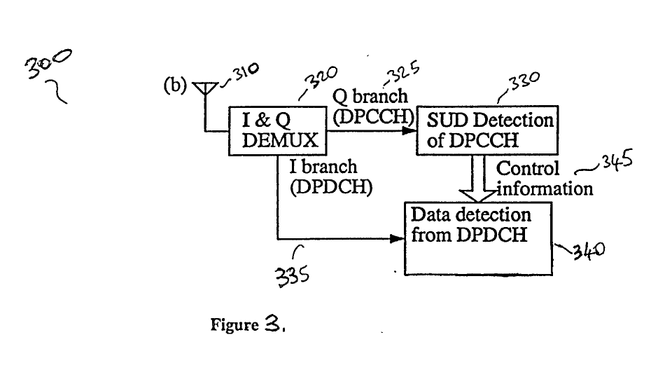

FIG. 2 illustrates a base station in a preferred embodiment of the present invention. The mobile stations 210 send their uplink signals 215 to the base station 240 using the same frequency band. In this system, codes may be used to distinguish between different user signals. These codes can be any orthogonal set of codes that, as discussed before, guarantees the lowest possible cross-correlation between the signals. An antenna 220 at the base station 240 receives the signals and sends them to the receiver 230 which separates each signal into the In-phase and the Quadrature components. The detection of the signals and the interference reduction process performed in the receiver is described hereinafter in detail with reference to FIG. 3. The receiver also contains other functionalities to allow it to operate properly as should be understood by one skilled in the art.

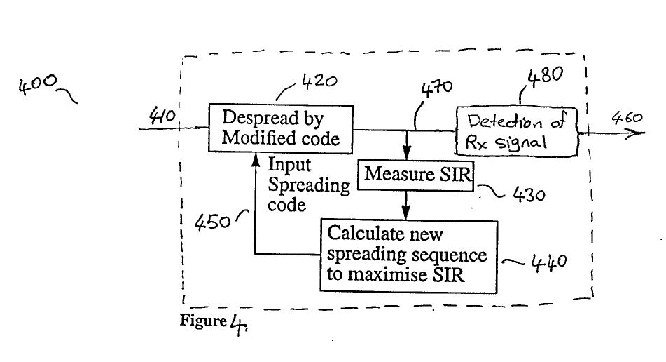

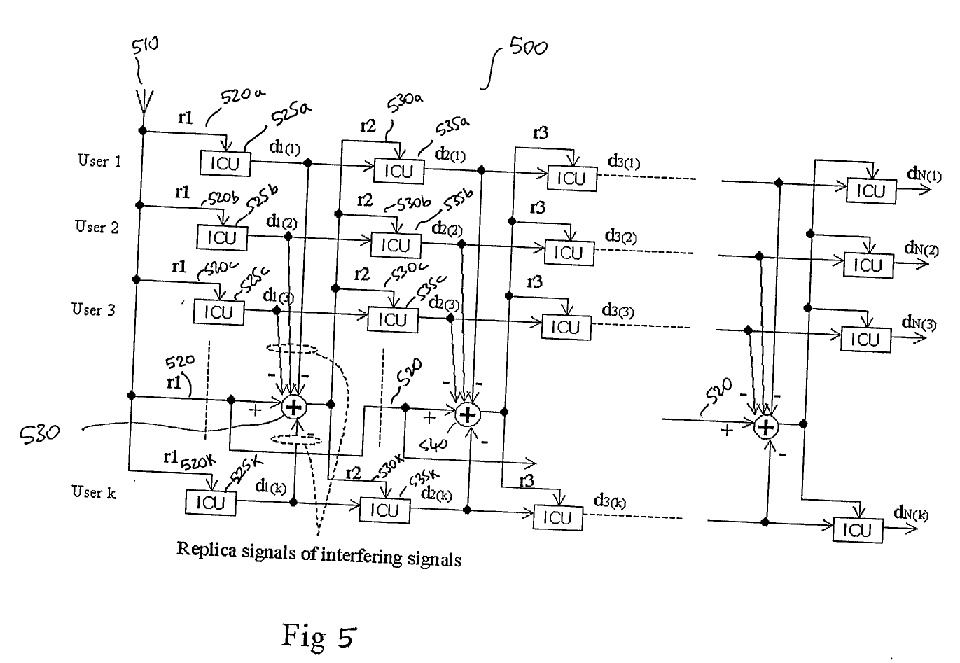

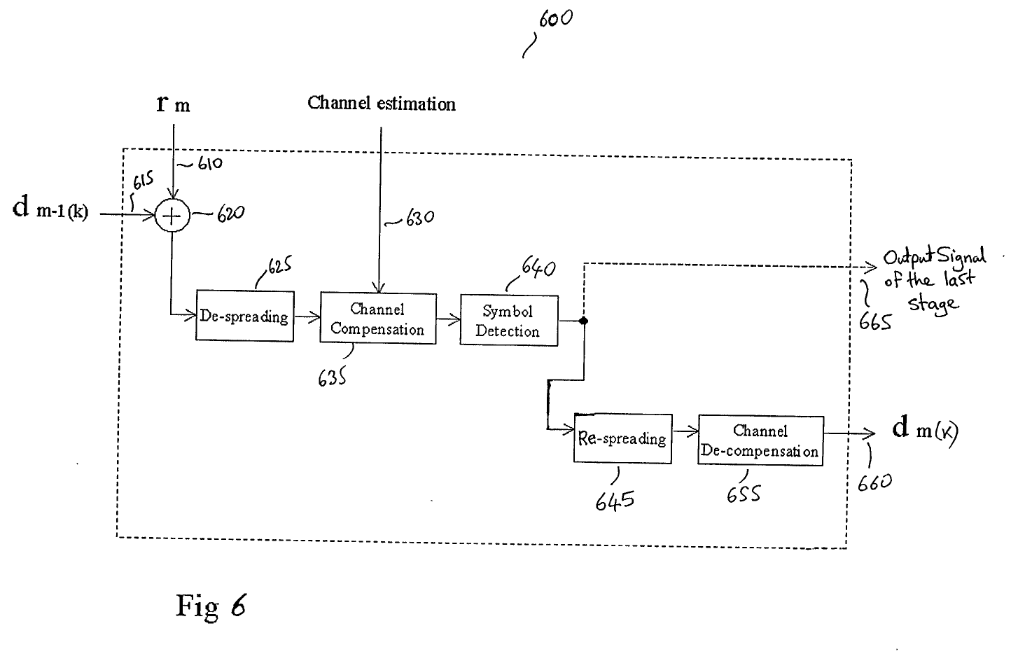

FIG. 3 illustrates a preferred embodiment of a receiver in a base station for receiving a CDMA signal. The radio frequency signal of all users sharing the same frequency in a CDMA system is received using an antenna 310. The signal is then demodulated, as is well known in the art, using the modulation scheme used for that particular system. These signals from all users are in one single high rate stream which is then passed through an I&Q demultiplexer 320 which separates each signal into an In-phase and a Quadrature component. The DPCCH 325 (Q part) is passed to a single user detection (SUD) unit 330 to detect the control part of the signal. This SUD unit 330 applies the spreading code/sequence of the user to the high rate signal. The control signal is now detected and signals of all other users appear as noise. The SUD unit 330 is not concerned with the codes of other users, since it despreads the desired user signal only. This SUD operation is being adapted to reduce the interference of other user signals in a way described hereinafter with reference to FIG. 4. Single user detection (SUD) techniques require spreading codes of the same length to be used on the signals to achieve an acceptable detection quality. Therefore, only the DPCCH 325 is passed through the SUD 330 unit, since the length of the control channel's spreading code is constant irrespective of the user data rate. However, the DPDCH 335 which requires different length spreading codes in multi-rate systems, is not passed by the SUD unit. The control information 345 including the power control symbols, the rate information and the pilot symbols, providing a channel estimation of the channel, are passed from the SUD 330 unit to a data detection unit 340. The control information is used to provide a better estimate of the channel used for communication, hence providing better data detection, as described hereinafter with reference to FIGS. 5 and 6. This enhanced channel estimate is used in the data detection occurring in the data detection unit 340. The DPDCH signal 335 is supplied from the demultiplexer concurrently with the control information 345 from the SUD 330 unit to the data detection unit 340. This data detection unit 340 may be a multi-user detection (MUD) unit or a single-user detection (SUD) unit.

FIG. 4 is a preferred embodiment of a single user detection (SUD) 330 interference suppressor. The control signal (DPCCH) received 410 is despread 420 using the user assigned code and/or spreading sequence. This user assigned code is unique for each user and is preferably orthogonal to other user codes. When a signal is multiplied by the user assigned code, only this particular user signal is recognized and all other users' signals appear as noise. The codes have to be exactly orthogonal in order for the despreading operation to generate a user signal well above the background noise of the other users' signals, i.e., an acceptable Signal-to-Interference Ratio (SIR). A preferred embodiment of the present invention maximizes the SIR of each user. The system measures 430 the SIR of each user to determine whether the signal strength is acceptable compared to the noise imposed by other users. The measured SIR 430 is used to calculate a new spreading sequence 440 to achieve the maximum SIR of the despread signal. This may be done by adjusting weights and various factors in the new spreading sequence calculating unit 440. Alternatively, this calculation of the new spreading sequence 440 may be done using an adaptive filter that adjusts its weights/coefficients so that a spreading sequence is generated that achieves the highest possible SIR. This adaptive filter could be any of the various well known filters, e.g. LMS filter, LS filter, RLS filter, etc. This recursive update is done by the filter to achieve a high Signal-to-Interference Ratio (SIR) of the received despread signals. The new/updated spreading code is used to despread the incoming received signals 410. This process is iterative and the system constantly updates its coefficients to generate a spreading sequence that guarantees the maximum possible SIR, i.e., best signal detection quality. The output of this adaptive process 470, the despread signal of the DPCCH, is then supplied to the data detection unit 480. The detection unit 480 detects the power control symbols, the rate information and the pilot symbols from the despread signals 470. Those detected signals 460 are supplied to the data detection unit 340 as the control information. The detection unit 480 may calculate the channel estimates factor in accordance with the detected symbols, e.g., pilot symbols, rate information and power control information, and then supply the channel estimation factor to the data detection unit 340. The calculated new spreading sequence 440 is used to despread the DPCCH which results in the suppression of interference in the signal. The Control Information which contains accurate information about the estimated channel response is used to better detect the data part of the signal, as shown hereinafter with reference to FIG. 6. The channel estimation is represented in the pilot symbols transmitted in the control part of the DPCCH signal, which consequently leads to a better interference cancellation scheme for the DPDCH channel. The SUD used to detect the control part of the signal, as mentioned herein, provides better estimates for the transmitted bits on the control channel. These estimates when used to detect the data part of the signal, provides better detection of the data part of the signal using a MUD, a SUD or a conventional receiver.

FIG. 5 illustrates a multi-user detector (MUD) in a preferred embodiment of the present invention used to detect the data part of a user signal. It should however be understood that the MUD described herein to detect the data part of the signal may be any detector for detecting a received signal such as a single user detector, a matched filter, etc. A multi-stage multi-user detector is illustrated in FIG. 5 as a preferred embodiment of the data detection unit. Signals 520 from different users are received in parallel (or serial) and are processed using spreading sequences of each user in the system. The spreading sequence used in the MUD for each user is the same as the sequence used in the transmitter for that particular user. The signal 520 is first passed through an interference cancellation unit (ICU) 525a-k. The interference cancellation unit 525a-k generates the replica signal of each user signal, using the received signal 520 and the spreading sequence of each user. Those replica signals are subtracted 530 from the received signal 520 as interfering signals, and then the residual signal 530 obtained by the subtraction process, along with each replica signal, is supplied to the interference cancellation unit 535a-k of the next stage. The interference cancellation unit 535a-k of the next stage generates the new replica signal of each user signal, using the residual signal 530, the replica signal of the previous stage and the spreading sequence of each user. Those new replica signals are subtracted 540 from the received signal 520 in the same manner as the previous stage. By repeating this process properly, the data detection with the interference cancellation operation is achieved. As shown in the multi-stage figure, this process may be performed several times. The more stages used in the detection process, the less interference of other users is present in the detected signal, hence more accurate detection is achieved.

FIG. 6 illustrates the interference cancellation unit (ICU) of the multi-user detector (MUD) described with reference to FIG. 5. For illustrative purposes, the ICU process of the mth stage of a specific user k is shown in the figure. However, it should be understood that all users at all stages incorporate similar, if not the same ICUs. The output 660 of the previous ICU process is feed forward as input to the input 615 of the ICU of the current stage denoted by reference numeral 600. Moreover, the ICU is supplied the residual signal 610 from the previous stage. (If m=1, the received signal 520 is supplied instead of the residual signal). The two signals (610, 615), mentioned hereinabove, are added together 620 and the sum is despread 625 using the spreading sequence of that particular user (k) . The despread signal for user k is channel compensated 635 using the channel estimates 630 determined in the single user detector (SUD) for the control part of the signal. The channel compensation process 635 corrects phase variations and/or amplitude variations suffered on the radio channel. The value of the channel estimation is calculated, e.g. using pilot bits of the DPCCH signal. Since more accurate symbol detection is achieved by the channel compensation process, the interference cancellation performance and the detection of the DPDCH signal is improved. Following the channel compensation 635, the symbols of that particular user signal are detected 640. The detected symbols are re-spread 645 by the spreading sequence of that particular user. After the re-spread process 645, the channel de-compensation process 655 is performed on the re-spread signal, using the inverse value of the channel estimation used at the channel compensation process 635, in order to generate the replica signal of the interfering signal which is included in the received signal 520 shown in FIG. 5. The output 660 of the channel de-compensation process is subtracted from the received signal as replica signal of interfering signals, as represented in reference numeral 530 in FIG. 5.

In a preferred embodiment of the present invention, the receiver could be flexible, meaning that the receiver determines whether the system is a multi-rate system e.g., Wideband CDMA (WCDMA), or a single-rate system e.g., IS-95 (CDMA), hence, the DPDCH and/or the DPCCH channels are detected using the SUD and/or the MUD. The receiver mainly detects data signals using the MUD in multi-rate systems and the SUD in single-rate systems. Therefore, the receiver may have two data detection units for detecting the DPDCH channel in different rate systems. Moreover, in a multi-rate system, if all users use the same rate, the receiver may switch its detection to use the SUD unit.

In a preferred embodiment of the present invention the data detection unit is a Multi-User Detection (MUD) unit. This MUD may be any Multi-user receiver such as Optimal or Sub-optimal receivers. Also the Sub-optimal receiver may be either linear or non-linear. In general any type of MUD receivers may be used depending on the nature of the network or the channel used. In another preferred embodiment, the data detection unit may be a single user detector. The single user detector is mainly used in single-rate systems whereas the MUD is used in multi-rate systems. In general, any conventional receiver or detection scheme may be used to provide detection of the DPDCH channel. However, some data detection schemes perform better than others in certain systems, as discussed hereinabove. It should however be understood by one skilled in the art that other data detection schemes could be used without deviating from the concepts of the present invention.

As described earlier with respect to the preferred embodiment of the present invention, using Single User Detectors (SUD) to detect the control part of the signal better estimates can be done of the transmitted bits on the control channel, i.e., pilot bits, rate information and power control commands. Using some, or all, of these improved estimates, a better channel estimation can be achieved. This improved channel estimation will improve the detection of the data part of the signal. This is true for all kind of detectors of the data channel, e.g., SUD, MUD and conventional receivers.

As will be recognized by those skilled in the art, the innovative concepts described in the present application can be modified and varied over a wide range of applications. Accordingly, the scope of patented subject matter should not be limited to any of the specific exemplary teachings discussed, but is instead defined by the following claims.

What is claimed is:

1. A telecommunications interference reduction system for detecting a received signal, said received signal having a control part and a data part therein, said system comprising:
a single user detection unit for detecting said control part of said received signal, said single user detection unit transmitting control information based upon said received signal; and
a data detection unit for detecting said data part of said received signal, said data detection unit receiving said control information from said single user detection unit, thereby facilitating said detection by said data detection unit of said data part of said received signal.

2. The system according to claim 1, further comprising a demultiplexer for separating said received signal into said control part and said data part.

3. The system according to claim 2, wherein the demultiplexer comprises an In-phase/Quadrature demultiplexer.

4. The system according to claim 1, wherein said control part of said received signal comprises a dedicated physical control channel (DPCCH).

5. The system according to claim 1, wherein said data part of said received signal comprises a dedicated physical data channel (DPDCH).

6. The system according to claim 1, wherein said single user detection (SUD) unit comprises an adaptive filter.

7. The system according to claim 6, wherein said control information comprises channel estimates.

8. The system according to claim 1, wherein said single user detection (SUD) unit comprises: a despreader for despreading said control part of said received signal using a spreading sequence;
a measuring device for measuring a Signal-to-Interference Ratio (SIR) of said despread control part of said received signal; and
a calculating device for calculating a new spreading sequence based on said SIR.

9. The system according to claim 8, wherein said despreader uses said new spreading sequence to despread said control part of said received signal.

10. The system according to claim 8, wherein said calculating device comprises an adaptive algorithm, said adaptive algorithm adjusting coefficients to maximize said SIR.

11. The system according to claim 1, wherein said data detection unit comprises a multi-user detection unit.

12. The system according to claim 1, wherein said data detection unit comprises a multi-stage multi-user detection unit.

13. The system according to claim 1, wherein said data detection unit comprises a single user detection unit.

14. An interference reduction method for detecting a received signal, said received signal having a control part and a data part therein, said method comprising the steps of:
a first detecting step for detecting said control part of said received signal;
transmitting control information based upon the detected control part of said received signal; and
a second detecting step for detecting said data part of said received signal, said transmitted control information being used to facilitate detection of said data part of said received signal.

15. The method according to claim 14, further comprising, prior to said first detecting step, the step of:
separating said received signal into said control part and said data part.

16. The method according to claim 15, wherein said separating step comprises separating said signal into an In-phase and a Quadrature components.

17. The method according to claim 14, wherein said control part of said received signal comprises a dedicated physical control channel (DPCCH).

18. The method according to claim 14, wherein said data part of said received signal comprises a dedicated physical data channel (DPDCH).

19. The method according to claim 14, wherein said first detecting step detects said control part of said received signal using an adaptive algorithm.

20. The method according to claim 14, wherein said first detecting step further comprises the steps of:
despreading said control part of said received signal using a spreading sequence;
measuring a quality factor of said despread control part of said received signal; and
calculating a new spreading sequence based on said quality factor.

21. The method according to claim 20, wherein said step of despreading comprises despreading said control part of said received signal using said new spreading sequence.

22. The method according to claim 20, wherein said quality factor comprises a Signal-to-Interference Ratio (SIR) factor.

23. The method according to claim 20, wherein said step of calculating comprises an adaptive calculating algorithm having adjustable adaptive coefficients, thereby maximizing said quality factor.

24. The system according to claim 14, wherein said data detection unit is selected from the group consisting of: a multi-user detection unit, a multi-stage multi-user detection unit, a single user detection unit, and any conventional detection unit.
